(19) United States
(12) Patent Application Publication
(10) Pub. No.: US 2017/0278206 A1
(43) Pub. Date: Sep. 28, 2017

(54) Digital Rights Management and Updates

(71) Applicant: Adobe Systems Incorporated, San Jose, CA (US)

(72) Inventor: Arun Anantharaman, Lost Altos Hills, CA (US)

(73) Assignee: Adobe Systems Incorporated, San Jose, CA (US)

(21) Appl. No.: 15/080,181

(22) Filed: Mar. 24, 2016

(51) Int. Cl. G06Q 50/18

(52) U.S. Cl. CPC G06Q 50/184; G06Q 2220/127

(57) ABSTRACT

Digital rights management update techniques are described. In one or more implementations, a digital rights management module embedded as part of content and used to control access to individual items of the content is updated. In one example, this update is configured to address a change is specified traits for a particular user population such that access continues to be accurately controlled for that user population. In another example, control actions used by the digital rights management module to control access to the content are updated based on changes to a behavior of a user population.

### BACKGROUND

Digital rights management is used to control use of content, e.g., to alter, consume, or distribute content. Current digital rights management techniques are based on qualities that are unique to a particular user. For example, a purchaser of an application from a conventional application store, a song from an online music store, and so on may be given access to the content via a user name and password of an account associated with the user for a corresponding service. Other conventional examples include persistent online authentication, unique content identifiers (e.g., CD keys), digital watermarks, and encryption keys associated with a particular user or user's device.

Each of these conventional techniques, however, is rigid and lacks an ability to address changes in how the content is to be consumed and thus limit usability of the content. Accordingly, this “all-or-nothing” approach to content access may be frustrating to consumers of the content and thus limit desired distribution of the content, and even force the creation of multiple versions of the content and consequently complicate distribution of this content to intended recipients. Further, these conventional techniques are also rigid due to an inability to address changes of traits and behaviors of a desired user population that is to consume the content.

### SUMMARY

Digital rights management update techniques are described. In one or more implementations, a digital rights management module is updated which is embedded as part of content and used to control access to individual items of the content. In one example, this update is configured to address a change in specified traits for a particular user population such that access continues to be accurately controlled for that user population. In another example, control actions used by the digital rights management module to control access to the content are updated based on changes in a behavior of a user population.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ digital rights management (DRM) and behavioral trait techniques described herein.

FIG. 2 depicts a system in an example implementation of creation of a DRM policy and subsequent content to be consumed by users included in a behavior.

FIG. 3 depicts a system,

FIG. 4 depicts an implementation, and

FIG. 5 depicts a procedure in which updates are used to update specified traits used as part of digital rights management to control access to items of content.

FIG. 6 depicts a system,

FIG. 7 depicts an implementation, and

FIG. 8 depicts a procedure in which updates are used to update control actions used as part of digital rights management to control access to items of content based on changes in behaviors.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

Overview

Conventional digital rights management techniques are rigid and inflexible and thus not able to take into account potentially changing traits of a behavior of a user that is to consume content. For example, conventional techniques typically rely on credentials that are particular to a user such that the credentials uniquely identify that user from each other user. Verification of these credentials is then used to grant access to the content in its entirety in these conventional techniques. This is because conventional credentials do not describe content consumption characteristics of the user.

A user name and password, for instance, may be used to control access to content obtained from an online music store, application store, and so on. Accordingly, the user name and password do not describe behaviors of a population, such as a way in which the population acts or conducts itself toward content. As such, although these conventional techniques may relate to the particular user, these techniques do not address traits of a population behavior that may include the user and thus are not capable of addressing changing traits of the behaviors of the users nor can these conventional techniques adapt to other users.

Digital rights management techniques are described that address traits of a behavior of a user population that is to consume the content. In one or more implementations, traits of a behavior are specified that are incorporated as part of a digital rights management policy for content. Analytics data, for instance, may be collected that describes a user population as a whole. A creator of a DRM policy may then select traits of behaviors for a target population as a subset of this user population to control content consumption by the subset of the user population. As described above, behaviors describe a way in which a user population acts or conducts itself toward content that is relevant to the population as a whole but is not particular to any specific user of that population.

In this way, access to all or portions (i.e., items) of the content may be controlled by a digital rights management module based on contemplated behaviors of consumers of the content, which is embedded as part of the content. For example, a marketer may wish to include an image as part of a marketing campaign for a population segment. The marketer may then specify traits of behaviors of the specific target population (e.g., content consumption characteristics related to age, gender, geographic location included as part of analytics data) to be implemented as part of a digital rights management policy as well as characteristics of content that is to be created.

The characteristics of the content as specified by the marketer are then used by a creative professional to create the content, which is then embedded with a digital rights management module that is configured to implement the digital rights management policy. Thus, in this example a workflow may be supported in which a target population and corresponding policy is first specified through interaction with analytics data and then used as a basis to create content for deployment.

Once deployed, the digital rights management (DRM) module may implement the digital rights management policy to dynamically address traits and changes to the traits of a behavior of users that consume the content. The DRM module, for instance, is configured to control access to different portions of the content based on which traits are met by a user requesting this access. Further, the access may be conditional, such as to permit access to one portion of content if a trait is met (e.g., traveling at a speed below a threshold) but a different portion of content if the trait is not met, e.g., traveling at a speed above the threshold. In this way, the marketers may specify how content is to be consumed, address potentially changing tastes and desires of users, as well as how the content is to be consumed dynamically as the user's traits change without changing the content itself Accordingly, a single item of content may dynamically change to address changing behaviors of users that are to consume the content which was not possible in conventional techniques, which thus required updates and changes to the content which would then be populated back to the users.

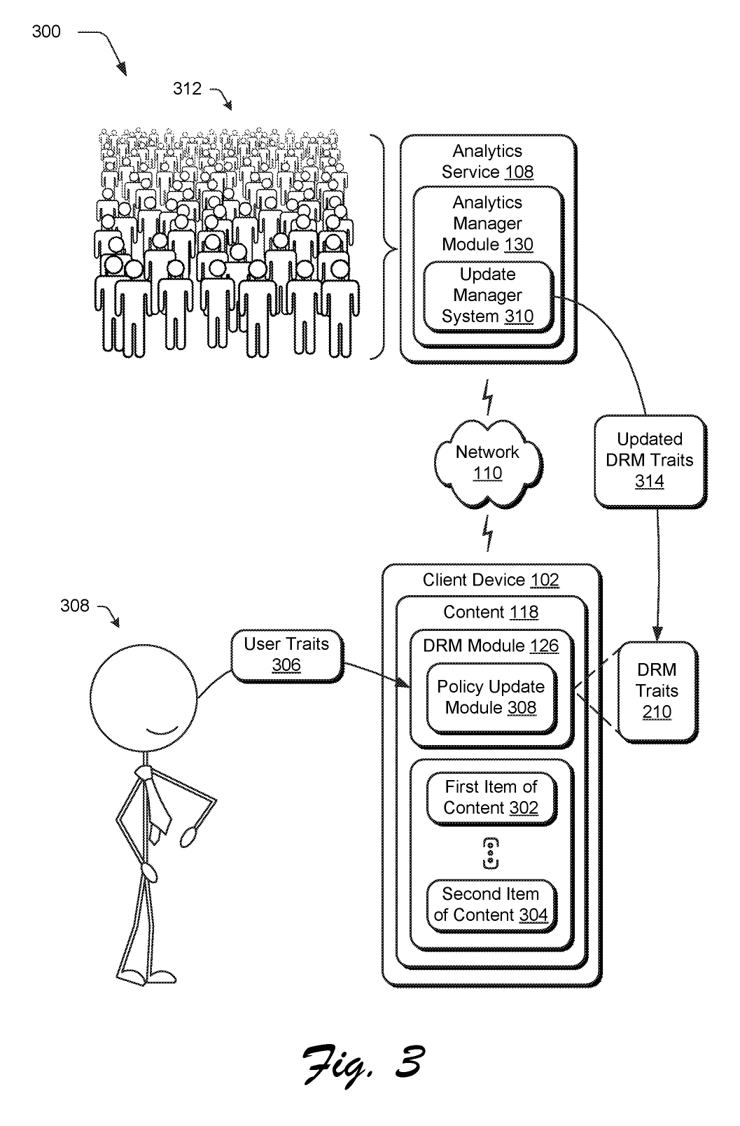

Additionally, functionality of the DRM module itself may also dynamically change to address changes in a user population that is to receive the content, including behaviors of the user population and control actions taken in response to traits of those behaviors. As described above, behaviors describe a way in which a user population acts or conducts itself toward content that is relevant to the user population as a whole. Accordingly, traits of the behaviors are used to define a user population and access to content that is permitted for that user population. However, in some instances the traits of the behaviors of this user population may change over time, and thus identification of this user population may also change which could lead to inaccuracies. Accordingly, in this example update techniques are described in which a user population is identified based on traits and subsequently monitored for changes to these traits. If a change is identified, an update is formed to update these specified traits such that the DRM module correctly address that user population, further discussion of which is described in relation to FIGS. 3-5 in the following.

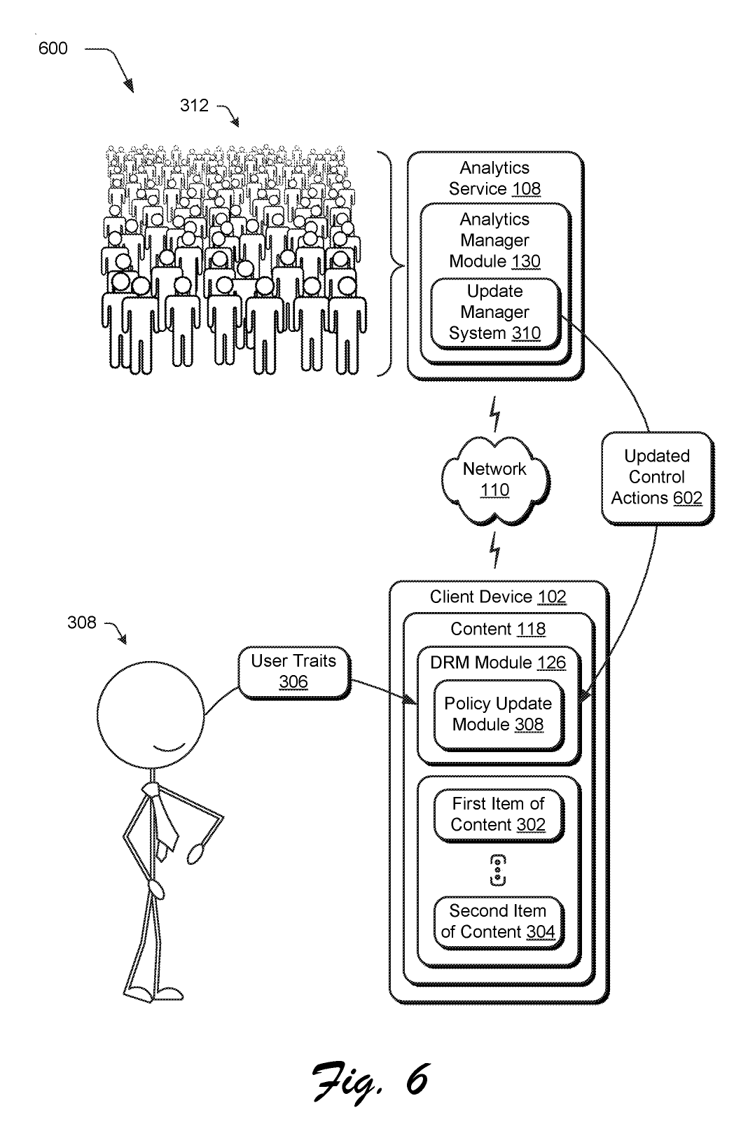

In another example, control actions are updated to dynamically address changes to content consumption. For example, behaviors of a user population to particular items of content may change. Accordingly, control actions implemented by the DRM module may change to address these changes such that a desired outcome is obtained, such as to change which advertisements are displayed to particular users. Further discussion of this example in described in relation to FIGS. 6-8 in the following.

In the description herein, content refers to a variety of different types of content, such as images, video, sound, and so on. Accordingly, characteristics of content to be created may describe a variety of visual and/or audio characteristics, such as objects to be included in an image, general look and feel of the image, types of sounds to be included in sound, locations for capture of video, and so forth. Digital rights management refers to access control techniques that are usable to control access to the content as a whole or particular portions of the content through use of a digital rights management policy, which in the following may be based on traits of a behavior. Traits of behaviors describe a way in which a user population acts or conducts itself toward content that is relevant to the population as a whole but is not particular to any specific user of that population, such as age group, gender, geographic location, profile, business status, group membership, device characteristics, motion or environmental traits, and so forth. Thus, traits met by a particular user are leveraged by the digital rights management policy to control access to content as a whole or particular portions of the content as further described below.

An example environment is first described that may employ the DRM techniques described herein. Example procedures are then described which may be performed in the example environment as well as other environments. Consequently, performance of the example procedures is not limited to the example environment and the example environment is not limited to performance of the example procedures.

Example Environment

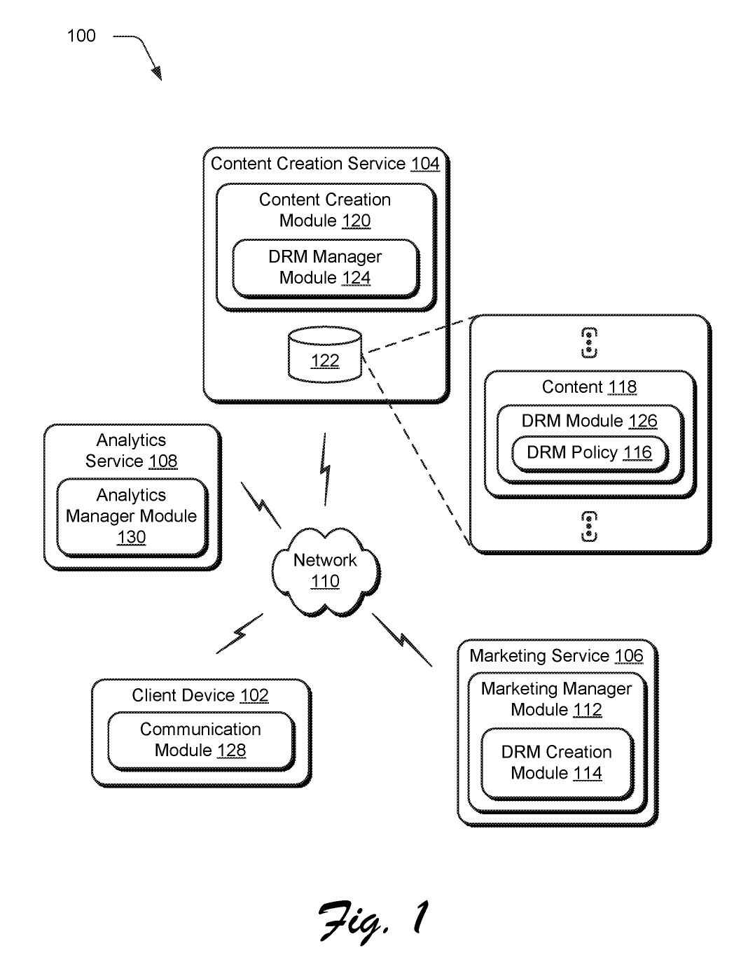

FIG. 1 is an illustration of an environment 100 in an example implementation that is operable to employ digital rights management and behavioral trait techniques described herein. The illustrated environment 100 includes a client device 102, a content creation service 104, a marketing service 106, and an analytics service 108 that are communicatively coupled, one to another, via a network 110. Each of these entities may be configured in a variety of ways using one or more computing devices.

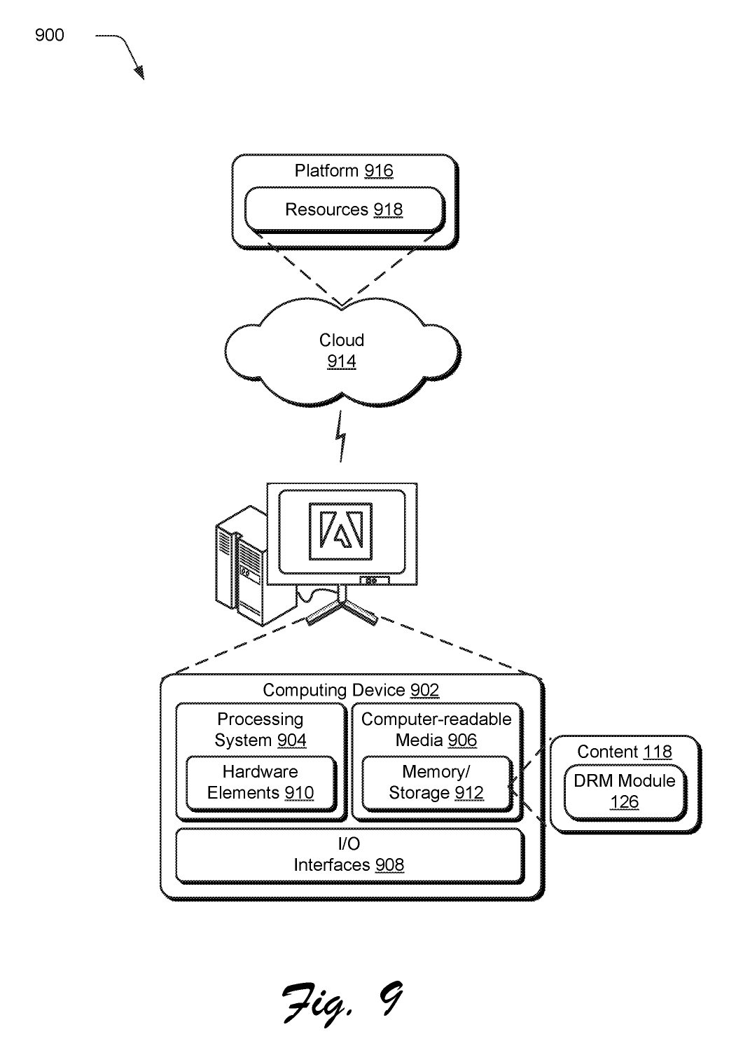

A computing device, for instance, may be configured as a desktop computer, a laptop computer, a mobile device (e.g., assuming a handheld configuration such as a tablet or mobile phone as illustrated), and so forth to implement the client device 102. Thus, the computing device may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers utilized by a business to perform operations “over the cloud” to implement the content creation service 104, the marketing service 106, and the analytics service 108 as further described in relation to FIG. 9.

The marketing service 106 is illustrated as including a marketing manager module 112. The marketing manager module 112 is representative of functionality to support user interaction to create a marketing campaign, track deployment of the marketing campaign, and so forth. A user, for instance, may interact with the marketing manager module 112 to specify a marketing campaign, items of content to be included in the campaign, and one or more behaviors of the campaign. The user may also interact with a DRM creation module 114 that is representative of functionality to specify traits of behaviors to form a DRM policy 116 to be utilized to manage access to content 118. The campaign, for instance, may be configured to control output of different images as a background based on age of users that access the content.

The marketing manager module 112 may employ analytics to generate analytics data (i.e., “big data”) that describes a user population, such as traits of behaviors as described above. Through interaction with the marketing manager module 112, a user may then select traits of behaviors of a target population from this data that are to be met by users to consume corresponding portions of content 118. For example, the marketing manager module 112 may output a user interface via which a user may select traits of behaviors for a desired target population (e.g., age, gender, job title), such as by selecting a check box, keyword input, and so forth. In this way, the user is provided with detailed knowledge of traits of behaviors of a target population and from this knowledge select traits of behaviors to be met to consume particular potions of the content 118, rather than guessing which traits could be met by a target population as performed in conventional techniques which may be prone to error and inefficient.

Data describing the content 118 to be created and the traits specified above as part of creation of the DRM policy 116 through interaction with the DRM creation module 114 is then provided to a content creation service 104 in this example. The content creation service 104 includes a content creation module 120 that is representative of functionality to create content 118, which is illustrated as stored in storage 122. A variety of content 118 may be created, such as webpages, advertisements, media including video and/or audio content, and so forth.

Continuing with the previous example, a user interacts with the content creation module 120 to create content 118 having characteristics as specified by the marketing service 106. As part of this creation, a DRM manager module 124 is used to embed a DRM module 126 as part of the content 118. The DRM manager module 124 is representative of functionality to control implementation of the DRM policy 116 as part of the content 118 during consumption of the content 118, e.g., by a communication module 128 (e.g., browser, web-enabled application) of the client device 102.

The DRM module 126 may be configured to determine traits of a user that requests access to the content 118 and provide access to portions of the content 118, if any, that correspond to those traits. For example, the DRM policy 116 may specify different backgrounds of an advertisement for different behaviors. Accordingly, the DRM module 126 determines traits of a user requesting access and provides access to corresponding portions of the content 118, e.g., the backgrounds. In this way, the DRM policy 116 as specified by the marketing service 106 in this example serves as a basis for creation of the content 118 and management of access to portions of the content 118. Examples that support additional complications and dynamic responses of DRM control are described in the following.

The DRM module 126 is configured to leverage data obtained from a variety of sources to determine traits associated with a user in order to control access. An example of one such source is illustrated as an analytics service 108 having an analytics manager module 130 that is representative of functionality to collect analytics data. This may include analytics data such as social network posts, webpages visited, items bought and so forth that is exposed via application programming interfaces by websites. This may also include tracking code that is embedded as part of content that exposes data describing usage of the content. Thus, the “big data” collected by the analytics service 108 from third-party sources may describe the user and content usage of the user which may then be used by the DRM module 126 to control interaction with the content 118 as further described below.

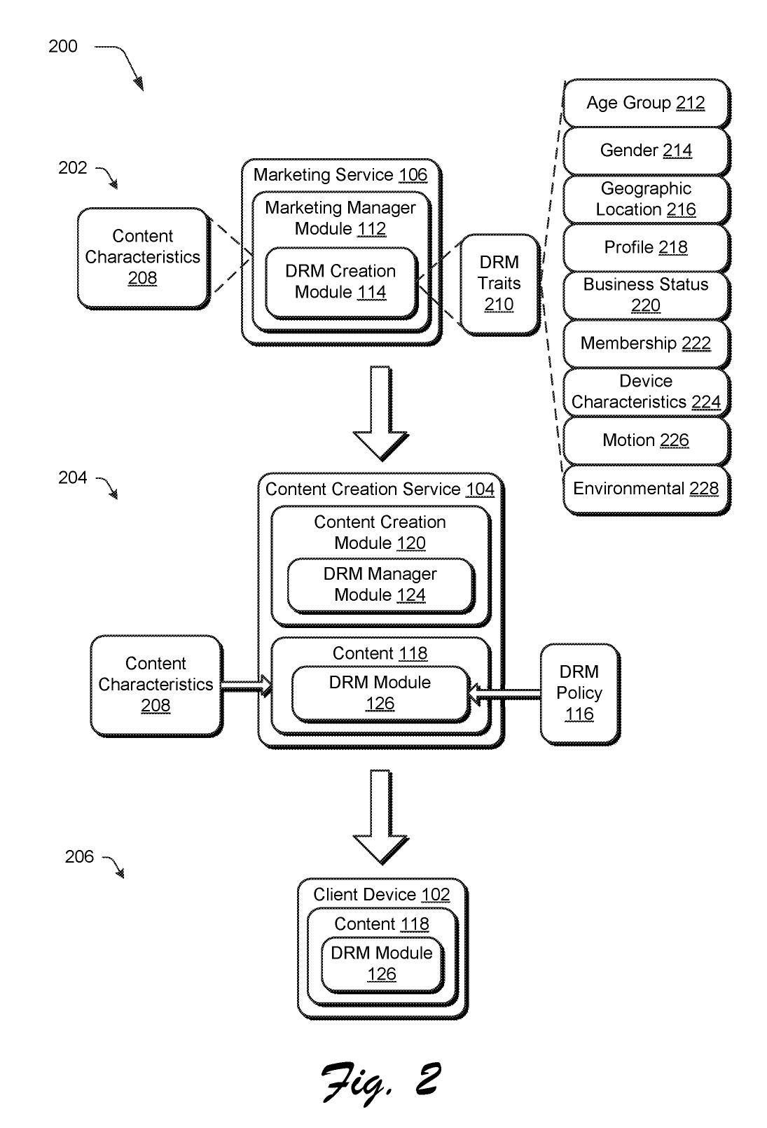

FIG. 2 depicts a system 200 in an example implementation of creation of a DRM policy and subsequent content to be consumed by users included in a target segment. The system 200 is illustrated using first, second, and third stages 202, 204, 206. At the first stage 202, user interaction with a marketing manager module 110 is used to specify content characteristics 208, e.g., for part of a marketing campaign. A variety of different content characteristics 208 may be specified, including type of content such as webpage, printed add, audio such as a jingle or song, video such as an instructional product video or dedicated product advertisement, legal contract. The content is also deliverable in a variety of ways, e.g., streaming or downloaded for local storage and subsequent playback.

The marketing manager module 112 as previously described also includes a DRM creation module 114. The DRM creation module 114 in this instance is representative of functionality to specify digital rights management (DRM) traits 210 of behaviors that are used to create a DRM policy 116 of the content creation service 104. The DRM policy 114 as previously described is configured to control content access by determining which traits of users are satisfied in order to gain access to portions of content. As described above, the DRM traits may be specified in a variety of ways, such as through selection of particular traits collected through analytics by the marketing service 106.

A variety of different DRM traits 210 may be specified, such as traits particular to a behavior but are not unique to individual members having the behavior, e.g., may be satisfied by a plurality of users. Examples of such behavioral traits that are usable to determine potential interaction of a user with content include age group 212 (e.g., particular age or age range), gender 214, geographic location 216 (e.g., based on IP address, city, state, region, country, continent), organizational associations such as profile 218 (e.g., traits included in a social network profile, business title in a business website, educational degrees achieved, particular skills), business status 220 (e.g., whether an associated business is in good standing, business certifications), group membership 222 (e.g., membership to a particular organization), and other traits such as device characteristics 224 of a device being used by the user to gain access (e.g., brand, hardware resources, software resources, display resources), and temporal traits (e.g., business hours, time of day, day of week, week of month, year). Additional examples of traits include motion 226 (e.g., motion exhibited by a user or a device making a request), environmental 228 (e.g., a user's surrounding or biometric to describe the user), and so forth.

At the second stage 204, a content creation module 120 of the content creation service 104 is used to create content 118 and a DRM module 126 to control access to the content 118 as specified by a DRM policy 116 created based on the specified DRM traits 210. A creative professional, for instance, may interact with the content creation module 120 of the content creation service 104 to create content 118 as specified by the content characteristics 208 received from the marketing service 106. The marketing service 106, for instance, may specify different images and the content characteristics 208 thereof to be used as alternatives as part of a marketing campaign based on the DRM traits 210. The creative professional may then create content 118 as specified.

The content creation module 116 also includes a DRM manger module 124 that is representative of functionality that is configured to implement the DRM policy 116 through embedding the DRM module 126 as part of the content 118. The DRM module 126, for instance, may be executable to determine DRM traits associated with consumption of the content 118. As described above, these may include DRM traits 210 of a behavior that are not specific to a particular user, including traits of a device used, age group, geographic location, and so forth.

Accordingly, the content 118 having the DRM module 126 may be provided to a client device 102 for consumption as shown at the third stage 206. The DRM module 126 may then be utilized to address differences in traits between users, such as gender 212. The DRM module 126 is also usable to address changes in the user, itself, such as change in age group 212, geographic location 216, business status 220 (e.g., job title), membership 222, motion 226, an environment 228 in which the user is location, and so on. Further, as the DRM module 126 is embedded as part of the content 118 this dynamic consumption may be performed offline without accessing a network, and thus may address limitations of conventional techniques that required access in order to serve different content, such as targeted advertisements as part of webpages that are obtained and not available locally until relevant characteristics of a user are determined.

The DRM module 126 itself may also be updated to dynamically address changes in traits of a user population as well as behaviors of the user population toward particular items of content. For example, the DRM module 126 may be configured to control access for a particular user population having traits of a behavior to a particular item of content as specified by an originator of the content 118. In this example, the originator of the content 118 desires to have access controlled for a particular user population, and that control is based on the specified traits of that population. However, in some instances the traits of that user population may change over time. Accordingly, techniques to update specified traits of the DRM module 126 are described in relation to FIGS. 3-5 to maintain an accurate relationship between access control and this user population.

In another example, behaviors of a user population toward particular items of content change. As previously described, behaviors describe a way in which a user population acts or conducts itself toward content that is relative to the population as a whole. Accordingly, changes in behaviors of a user population may change how this population reacts to particular content. Accordingly, updates may be formed to change control actions performed by the DRM module 126 to address these changes in behavior, further discussion of which is described in relation to FIGS. 6-8.

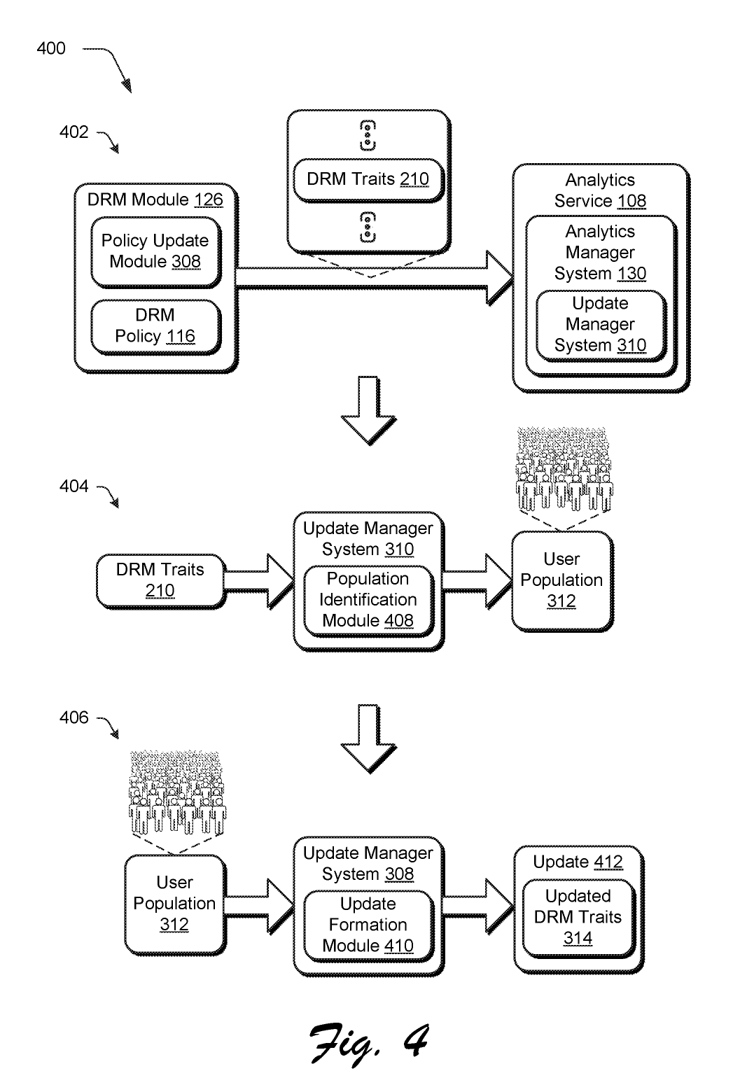

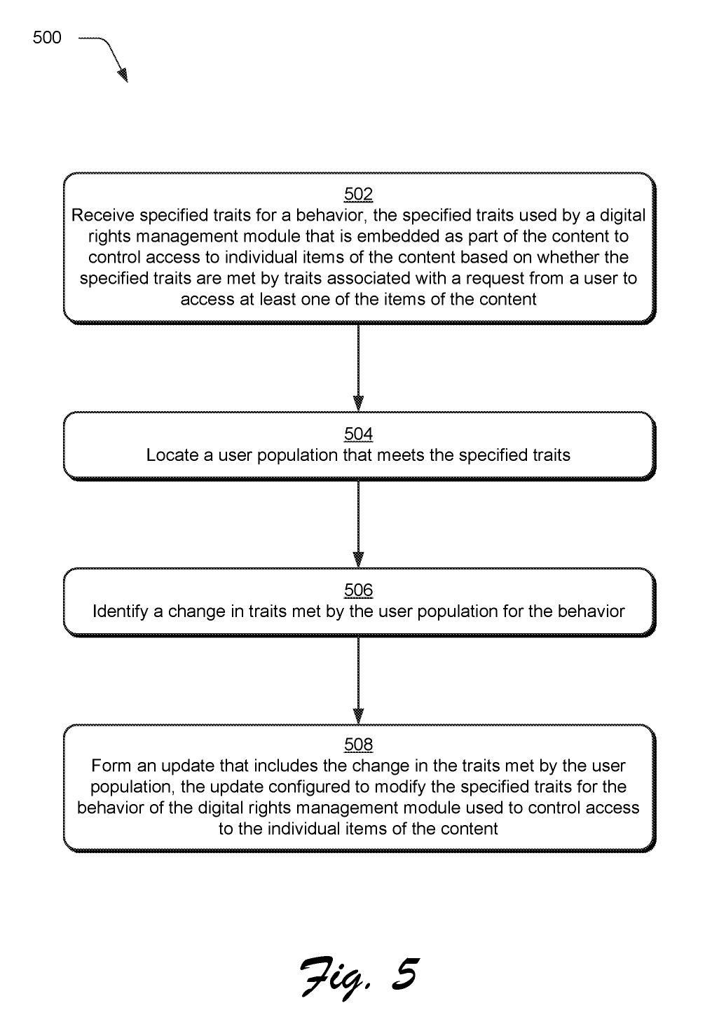

FIG. 3 depicts a system 300, FIG. 4 depicts an implementation 400, and FIG. 5 depicts a procedure 500 in which updates are used to update specified traits used as part of digital rights management to control access to items of content. The following discussion refers interchangeably to FIGS. 3-5 in order to illustrate an example of how updates to a specified trait are identified and formed. As illustrated in FIG. 1, content 118 includes a DRM module 126 to control access to first and second items 312, 314 of the content 118 based on user traits 306 as previously described. In some instances, however, the user traits 306 that are used to identify the user 308 and a particular user population may change over time, but control based on that user population is still desired by a creator of the content 118.

Accordingly, the DRM module 126 in this instance includes a policy update module 308 that is representative of functionality implemented at least partially in hardware to update the DRM traits 210 that are used to control user access. For example, the DRM traits 210 may be provided by the policy update module 308 to an update manager system 310 of an analytics service 108. The update manager system 310 is representative of functionality implemented at least partially in hardware to monitor a user population 312 corresponding to those traits and identify changes in traits of that user population 312 that may occur over time. These changes are then used to generate updated DRM traits 314 that are then communicated to the policy update module 308 to update the DRM traits 210 used to control access to the first and second items of content 302, 304 by the DRM module 126. In this way, the DRM module 126 may be dynamically updated to address changes in traits of a user population that is to consume the content. For example, traits such as income, business status, and so on of a particular user population may change and updates may be used to address this change, an example of which is further described below.

FIG. 4 is illustrated using first, second, and third stages 402, 404, 406. At the first stage 402, specified traits (e.g., DRM traits 210) for a behavior are received. The specified traits are used by a digital rights management module that is embedded as part of the content to control access to individual items of the content based on whether the specified traits are met by traits associated with a request from a user to access at least one of the items of the content (block 502). As previously described in relation to FIG. 2, the specified traits may pertain to the user, devices used by the user, an environment of the user, and so forth.

These DRM traits 210 are communicated in this example by the policy update module 308 of the DRM module 126 embedded as part of the content 118 itself and communicated over a network to an analytics service 108. Other examples are also contemplated, such as to communicate the DRM traits 210 to the analytics service 108 by a creator of the content 118 as part of an update process for the content, the updates then distributed to the DRM modules 126 as appropriate.

The analytics service 108 includes an update manager system 310 that is configured to generate an update based on the DRM traits 210. In this example, the update is to address changes in traits that identify a user population, which may be used to maintain consistency of how the DRM module 126 controls access to that user population.

As shown at the second stage 404, a user population is located that meets the specified traits (block 504). To do so, the update manager system 310 employs a population identification module 408 having logic implemented as least partially in hardware to identify a user population 312 from analytics data that meets the DRM traits 210. The analytics data may be obtained from a variety of sources, such as websites, social network services, user-supplied information, and so forth. In this way, the population identification module 408 may identify a user population 312 that currently meets the DRM traits 210.

A change is identified in traits met by the user population for the behavior (block 506). The population identification module 408, for instance, may continue to monitor users included in the user population 312 to identify a change, if any, in traits of that user population. This may include changes in the users, devices employed by the users, an environment in which the users are disposed, and so forth. Examples of such traits include age group 212 (e.g., particular age or age range), gender 214, geographic location 216 (e.g., based on IP address, city, state, region, country, continent), organizational associations such as profile 218 (e.g., traits included in a social network profile, business title in a business website, educational degrees achieved, particular skills), business status 220 (e.g., whether an associated business is in good standing, business certifications), group membership 222 (e.g., membership to a particular organization), and other traits such as device characteristics 224 of a device being used by the user to gain access (e.g., brand, hardware resources, software resources, display resources), and temporal traits (e.g., business hours, time of day, day of week, week of month, year). Additional examples of traits include motion 226 (e.g., motion exhibited by a user or a device making a request), environmental 228 (e.g., a user's surrounding or biometric to describe the user), and so forth.

Responsive to the identification of the change, an update is formed that includes that change in the traits met by the user population. The update is configured to modify the specified traits for the behavior of the digital rights management module used to control access to the individual items of the content (block 508). An update formation module 410, of the update manager system 308, implemented at least partially in hardware may be employed to form an update that includes DRM traits that now define the user population, which may include preexisting traits as well as any new traits that have been identified. This update is then communicated to the DRM module 126 as an update to the DRM policy 116 to control access to items of the content. In this way, the DRM module 126 is dynamically updated to address changes in traits to a user population in order to maintain control of access to that user population in a consistent manner Changes to behaviors of the user population may also be addressed, an example of which is described in the following and shown in a corresponding figure.

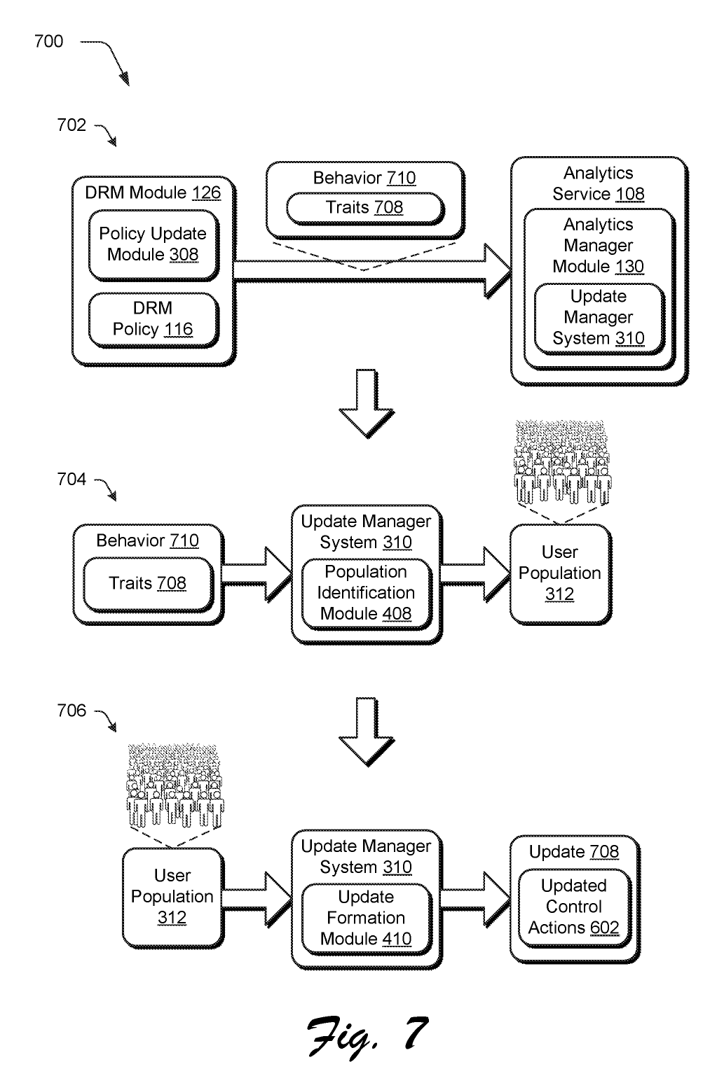

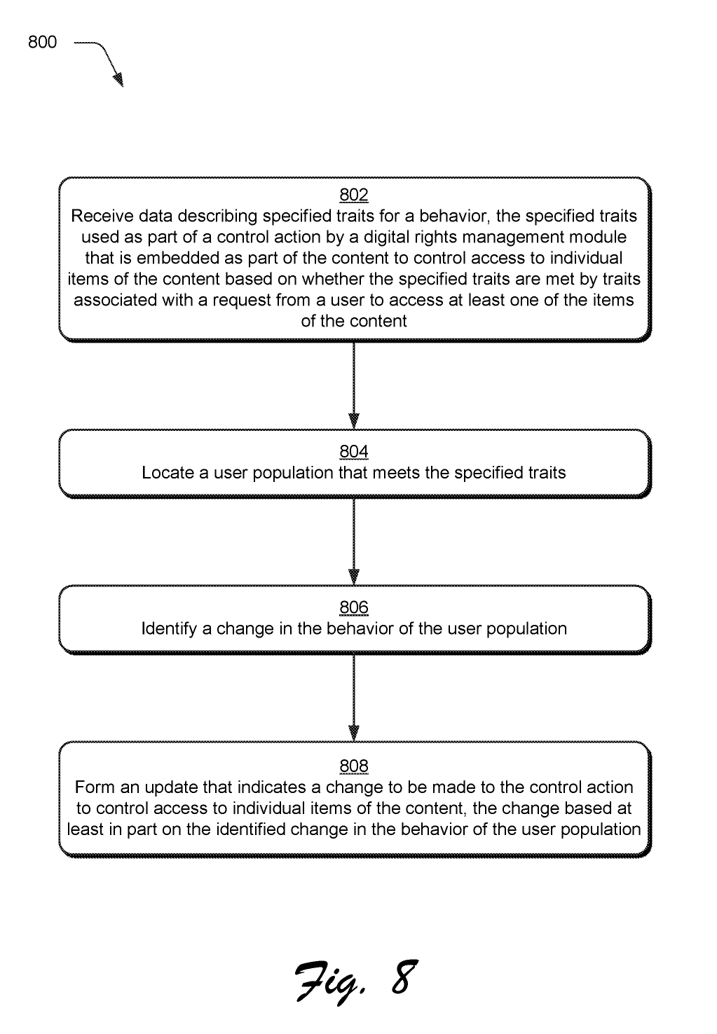

FIG. 6 depicts a system 600, FIG. 7 depicts an implementation 700, and FIG. 8 depicts a procedure 800 in which updates are used to update control actions used as part of digital rights management to control access to items of content based on changes in behaviors. The following discussion refers interchangeably to FIGS. 6-8 in order to illustrate an example of how updates to a specified trait are identified and formed. As before, content 118 includes a DRM module 126 to control access to first and second items 312, 314 of the content 118 based on user traits 306 as previously described. In some instances, however, behaviors of the user 308 toward particular items of the content 118 has changed.

To address this change, the policy update module 308 also communicates with the update manager system 310. However, the update manager system 310 in this instance identifies a change in a behavior of the user population 312. Behaviors describe a way in which the user population 312 acts or conducts itself toward content that is relevant to the population as a whole. Accordingly, identified changes in behavior of this user population 312 are used to update control actions 602 used by the DRM module 126 to control access to the content 118. In this way, the DRM module 126 may dynamically react to how changes in how a user population 312 acts to content over time.

FIG. 7 is illustrated using first, second, and third stages 702, 704, 706. At the first stage 702, specified traits 708 (e.g., DRM traits 210) for a behavior 710 are received. The specified traits are used as part of a control action by a digital rights management module that is embedded as part of the content to control access to individual items of the content based on whether the specified traits are met by traits associated with a request from a user to access at least one of the items of the content (block 702). As previously described in relation to FIG. 2, the specified traits may pertain to the user, devices used by the user, an environment of the user, and so forth.

These DRM traits 210 are communicated in this example by the policy update module 308 of the DRM module 126 embedded as part of the content 118 itself and communicated over a network to an analytics service 108. Other examples are also contemplated, such as to communicate the DRM traits 210 to the analytics service 108 by a creator of the content 118 as part of an update process for the content, the updates then distributed to the DRM modules 126 as appropriate.

As before, the analytics service 108 includes an update manager system 310. The update manager system 310 in this example, however, is configured to generate an update based on changes in a behavior of the user population 312 to items of content. Thus, in this example, the update is to address changes in how a user population 312 reacts, rather than changes in how the user population is identified as in the previous example.

As shown at the second stage 404, a user population is located that meets the specified traits (block 504). To do so, the update manager system 310 employs a population identification module 408 having logic implemented as least partially in hardware to identify a user population 312 from analytics data that meets the DRM traits 210. The analytics data may be obtained from a variety of sources, such as websites, social network services, user-supplied information, and so forth. In this way, the population identification module 408 may identify a user population 312 that currently has DRM traits 210 of the behavior in question.

Once the user population is identified, a change in the behavior of the user population is identified (block 806). For example, the population identification module 408 identifies the user population as described above. Machine learning is then performed, which may include matrix factorization, to learn behaviors of how this user population acts towards particular items of content. Machine learning may continue to be employed over time, therefore, to recognize changes in these learned behaviors. The user population, for instance, may change from favorable to unfavorable reactions to particular types of content, e.g., holiday-related themes after a holiday, artists that are no longer considered current, and so forth.

Based on this at the third stage 706, an update 708 is formed by the update formation module 410 that indicates a change to be made to the control action 312 to control access to individual items of the content. The change is based at least in part on the identified change in the behavior of the user population (block 808). Therefore, not only is the DRM module 126 able to react dynamically to user traits in how a user population 312 is identified as described in relation to FIGS. 3-5, but the control actions of a DRM policy 116 may also change to address changes in behavior of the user population 312.

Example System and Device

FIG. 9 illustrates an example system generally at 900 that includes an example computing device 902 that is representative of one or more computing systems and/or devices that may implement the various techniques described herein. This is illustrated through inclusion of the content 98 and DRM module 129. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, implementation of functionality described herein may be distributed throughout the system 900. For example, the functionality may be implemented in part on the computing device 902 as well as via the platform 916 that abstracts the functionality of the cloud 914.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to update access control of content by digital rights management functionality embedded as part of the content, a method implemented by a computing device, the method comprising:
receiving specified traits for a behavior by the computing device, the specified traits used by a digital rights management module embedded as part of the content to control access to individual items of the content based on whether the specified traits are met by traits associated with a request from a user to access at least one of the items of the content;
locating a user population, by the computing device, meeting the specified traits;
identifying a change in traits met by the user population for the behavior by the computing device; and
forming an update including the change in the traits met by the user population, the update configured to modify the specified traits for the behavior of the digital rights management module used to control access to the individual items of the content.

2. The method as described in claim 1, wherein the specified traits of the behavior are not unique to the user and are usable to define the behavior of a user population as a whole such that a plurality of said users are likely to meet the characteristics.

3. The method as described in claim 1, wherein the digital rights management module is embedded as part of the created content such that the one or more portions are available offline to the digital rights management module locally and without network access.

4. The method as described in claim 1, wherein the digital rights management module is configured to control access such that access to a first said portion of the content is made available when a first set of said traits are met and access to a second said portion of the content is made available when a second set of said traits are met.

5. The method as described in claim 4, wherein the first and second set of said traits are mutually exclusive such that the user that meets the first set of said traits cannot meet the second set of said traits.

6. The method as described in claim 1, wherein the locating is performed by the computing device using machine learning.

7. The method as described in claim 1, wherein the specified traits describe:
the user that is associated with the request;
an environment of the user that is associated with the request; or
a computing device employed by the user that is associated with the request.

8. The method as described in claim 1, wherein the specified traits include age group, gender, geographic location, profile, business status, membership, device characteristics, motion, or environmental.

9. The method as described in claim 1, wherein the locating and the identifying are performed automatically and without user intervention by the computing device.

10. In a digital medium environment to update access control of content by digital rights management functionality embedded as part of the content, a method implemented by a computing device, the method comprising:
receiving data describing specified traits for a behavior by the computing device, the specified traits used as part of a control action by a digital rights management module embedded as part of the content to control access to individual items of the content based on whether the specified traits are met by traits associated with a request from a user to access at least one of the items of the content;
locating a user population, by the computing device, meeting the specified traits;
identifying a change in the behavior of the user population by the computing device; and
forming an update that indicates a change to be made to the control action to control access to individual items of the content by the computing device, the change based at least in part on the identified change in the behavior of the user population.

11. The method as described in claim 10, wherein the specified traits of the behavior are not unique to the user but rather are usable to define the behavior of a user population as a whole such that a plurality of said users are likely to meet the characteristics.

12. The method as described in claim 10, wherein the locating, the identifying, and the forming are performed by the computing device automatically and without user intervention.

13. The method as described in claim 10, wherein the change made to the control action causes a change in which individual items of the content are accessible to the user by the digital rights management module.

14. The method as described in claim 10, wherein the change made to the control action causes a change in which individual items of the content are not accessible to the user by the digital rights management module.

15. The method as described in claim 10, wherein one of more of the individual items of content are advertisements.

16. In a digital medium environment to update access control of content by digital rights management functionality embedded as part of the content, an update manager system comprising:
a population identification module implemented at least partially in hardware to locate a user population meeting specified traits for a behavior, the specified traits used by a digital rights management module that is embedded as part of the content to control access to individual items of the content based on whether the specified traits are met by traits associated with a request from a user to access at least one of the items of the content; and
an update formation module implemented at least partially in hardware to identify a change in traits met by the user population for the behavior and form an update that includes the change in the traits met by the user population, the update configured to modify the specified traits for the behavior of the digital rights management module use to control access to the individual items of the content.

17. The system as described in claim 16, wherein the location of the user population is performed by the population identification module using machine learning.

18. The system as described in claim 16, wherein the specified traits include age group, gender, geographic location, profile, business status, membership, device characteristics, motion, or environmental.

19. The system as described in claim 16, wherein the specified traits describe:
the user that is associated with the request;
an environment of the user that is associated with the request; or
a computing device employed by the user that is associated with the request.

20. The system as described in claim 16, wherein the update formation module is configured to identify the change and form the update automatically and without user intervention.
